(19) United States
(12) Patent Application Publication
(10) Pub. No.: US 2025/0048497 A1
(43) Pub. Date: Feb. 6, 2025

(54) Chromium Electrodes to Deliver Electric Power to Oxide Brick Circuits

(71) Applicant: Electrified Thermal Solutions, Inc., Medford, MA (US)

(72) Inventors: Joey Kabel, Arlington, MA (US); Daniel Stack, Cambridge, MA (US)

(21) Appl. No.: 18/791,024

(22) Filed: Jul. 31, 2024

Related U.S. Application Data
(60) Provisional application No. 63/516,992, filed on Aug. 1, 2023.
(60) Provisional application No. 63/516,994, filed on Aug. 1, 2023.

(51) Int. Cl. H05B 3/03; F28D 20/00; H05B 3/14; H05B 3/24

(52) U.S. Cl. CPC H05B 3/03; H05B 3/141; H05B 3/24; F28D 20/00; F28D 20/0056; H05B 2203/007

(57) ABSTRACT

An electrically conductive brickwork module is used in a resistive heating or thermal energy storage system. The brickwork module includes an electrode constructed with metallic chromium physically and electrically connected to one or more electrically conductive bricks. The electrode is operational at temperatures in excess of 1300 C, or in some instances in excess of 1500 C. In some instances the electrodes are constructed of ceramic bricks having internally incorporated metallic agglomerates.

### CROSS REFERENCE TO RELATED APPLICATIONS

This application claims priority from U.S. Provisional Application Nos. 63/516,992 and 63/516,994, each filed Aug. 1, 2023, the disclosures of which are incorporated by reference herein in their entirety. This application incorporates by reference, in their entireties, each of the following related and commonly owned provisional applications filed on even date herewith and having the following titles: Gas Turbine with an Electrically Heated Thermal Energy Storage System, U.S. application Ser. No. ______; Electrically Conductive Brick Assembly for Use in a Heating and/or Thermal Storage System, U.S. application Ser. No. ______; Ceramic-Metal Composites for Use as Heating Elements for Electrified Resistance Heating and Thermal Energy Storage Systems, U.S. application Ser. No. ______; Electrically Conductive Brickwork Module for Use as a Heating and/or Thermal Storage System, U.S. application Ser. No. ______; Modulating Electrical Resistance along a Column of E-Bricks, U.S. Provisional Application No. ______; and Bent Pipe-Shaped Electrically Conductive Cross Brick Design, U.S. Provisional Application No. ______.

### TECHNICAL FIELD

The present disclosure relates to electrodes comprising metallic chromium, and more particularly to such electrodes used to deliver electric power to electrically conductive oxide brick circuits. The present disclosure further relates to ceramic metal composites for use as electrodes and resistive heating elements, and more particularly for use in electrified direct resistance heating and thermal energy storage systems.

### BACKGROUND ART

An electrically conductive firebrick system is described in U.S. Pat. No. 11,877,376, incorporated herein by reference in its entirety. This system uses specially constructed firebricks made with Cr₂O₃ to provide a resistive heating and energy storage solution.

To inject electricity into a firebrick system in a commercial furnace system, for example, the standard method for connecting an electrode to a circuit element is to clamp an aluminum wire braid to an aluminized end surface of the element that extends beyond the shell wall of the furnace. However, because aluminum has a melting temperature off 660 C—lower than the typical operating temperature of such a furnace—to prevent the aluminum wire from melting a portion of the element is typically larger in diameter to reduce current density, reduce local resistive heating and is kept cool by convective heat transfer with the surrounding environment. This larger diameter poses a challenge in existing stacked brick designs because it can extend beyond the outside of the brickwork system. As such, it is advantageous to bring the electrode material into the core of the stacked oxide bricks, which requires the use of high temperature (>1500 C) material for the electrode.

### SUMMARY OF THE EMBODIMENTS

In accordance with embodiments of the invention, an electrically conductive brickwork module is configured for use in a resistive heating or a thermal energy storage system. The electrically conductive brickwork module includes a plurality of electrically interconnected conductive bricks and an electrode comprising metallic chromium physically and electrically connected to at least one electrically conductive brick of the plurality of electrically conductive bricks, the electrode being configured for connection to an electrical source.

In some embodiments, the electrically interconnected conductive bricks include about 40 wt % to about 100 wt % Cr₂O₃, and may further include about 0 wt % to about 60 wt % Al₂O₃.

In some embodiments, the metallic chromium of the electrode comprises a chromium alloy. In some such embodiments, chromium alloy includes an element selected from the group consisting of Fe, Al, Ni, Mg, Mo, W, N, C, and combinations thereof. In some embodiments, the chromium alloy includes from about 5 at % to about 50 at % of metal selected from the group consisting of Fe, Al, Ni, and combinations thereof. In some embodiments, the chromium alloy includes from about 35 at % to about 45 at % C. In some embodiments, the chromium alloy includes about 45 at % to about 55 at % N. In some embodiments, the chromium alloy includes from about 0.1 at % to about 5 at % Mg.

According to some embodiments, the metallic chromium of the electrode has a melting temperature above about 1300 C. According to some embodiments the metallic chromium has a melting temperature above about 1500 C

According to some embodiments, the electrically conductive brickwork module has an exterior surface and an interior region enclosed by the exterior surface, wherein the electrode is disposed in the interior region, making electrical contact therein with the one or more electrically conductive bricks of the plurality of electrically conductive bricks. For some such embodiments, the exterior surface is thermally insulating, and the electrode is inserted through the exterior thermally insulating surface. For some such embodiments for which the electrode is disposed in the interior region, the electrically conductive brickwork module is configured for operation at temperatures above about 1300 C. For some such embodiments, the electrically conductive brickwork module is configured for operation at temperatures above about 1500 C.

According to some embodiments, the electrode of the electrically conductive brickwork module includes agglomerates of metallic chromium in a ceramic Cr₂O₃ matrix, which ceramic Cr₂O₃ matrix may further include Al₂O₃. For some such embodiments, the volume percentage of metallic chromium in the electrode is between about 5 vol % and about 50%.

Further disclosed herein is an electrode configured to provide electric power at temperatures above about 1300 C, in some embodiments above about 1500 C, to an electrically conductive brickwork module, the electrode comprising metallic chromium agglomerates in a ceramic matrix comprising Cr₂O₃. In some such embodiments the percent by volume of metallic chromium in the ceramic matrix is between about 5 vol % and about 50 vol %.

### BRIEF DESCRIPTION OF THE DRAWINGS

The foregoing features of embodiments will be more readily understood by reference to the following detailed description, taken with reference to the accompanying drawings, in which:

FIG. 1 provides a perspective view of an exemplary E-TESS system according to an aspect of this disclosure.

FIG. 2 provides a cross-sectional view of the exemplary E-TESS system of FIG. 1.

FIG. 3 provides a perspective view of an exemplary electrically conductive brick of the E-TESS system according to an aspect of this disclosure.

FIG. 4 provides a perspective view of an exemplary electrically insulative brick of the E-TESS system according to an aspect of this disclosure.

FIG. 5 provides a cross-sectional view of an exemplary E-TESS system according to an aspect of this disclosure depicting a circuit of electrically conductive brick connected to input and output electrodes.

FIG. 6 shows embodiments of ceramic metal composites (CERMETs).

### DETAILED DESCRIPTION OF SPECIFIC EMBODIMENTS

The disclosure and the various features and advantageous details thereof are explained more fully with reference to the non-limiting embodiments and examples that are described and/or illustrated in the accompanying drawings and detailed in the following description. Various aspects of the subject matter discussed in greater detail below may be implemented in any of numerous ways, as the subject matter is not limited to any particular manner of implementation. Examples of specific implementations and applications are provided primarily for illustrative purposes.

Unless otherwise defined, used, or characterized herein, terms that are used herein (including technical and scientific terms) are to be interpreted as having a meaning that is consistent with their accepted meaning in the context of the relevant art and are not to be interpreted in an idealized or overly formal sense unless expressly so defined herein. The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms “includes,” “including,” “comprises,” and “comprising” specify the presence of the stated elements or steps but does not preclude the presence or additional of one or more other elements or steps.

Definitions. As used in this description and the accompanying claims, the following terms shall have the meanings indicated, unless the context otherwise requires:

In the context of this application, an “alloy” is a mixture of a metal with other elements, wherein the mixture has predominantly metallic properties, including electrical and thermal conductivity, luster, and ductility. Common alloys include mixture of metals with other metals. Alloys can also include mixtures with non-metallic elements, in particular with carbon and nitrogen.

“Interstitial compounds,” including some carbides and nitrides, for which larger metal atoms (in particular chromium atoms) provide a host lattice for smaller atoms (e.g. C and N), are—in the context of this application—defined as “alloys.” Such compounds have primarily metallic character, reflecting the metallic bonding between the larger metal atoms in the lattice, in particular they are electrically conductive due to the presence of metallic conduction electrons.

The term “metallic chromium” encompasses chromium and chromium alloys.

This disclosure is directed to the use of metallic chromium in electrodes. In some instances the metallic chromium is present as pure chromium or as a chromium alloy. In some instances the metallic chromium is present as metal agglomerates in a ceramic matrix. An electrode made with metallic chromium having a melting temperature in excess of 1500 C can provide an electrical connection to deliver electrical power directly to an oxide brick circuit in a resistive heating system, and in particular to a resistive heating system for thermal energy storage. This electrical connection is critical to the operation and longevity of the oxide brick circuit. Such electrodes may comprise material selected from the group consisting of chromium metal, chromium alloys, and metallic chromium present as agglomerates in a ceramic matrix, in particular in a ceramic matrix of Cr₂O₃ and Al₂O₃.

At high volume percentages, metallic chromium present as agglomerates in a ceramic matrix of Cr₂O₃ and Al₂O₃, ceramic bricks may be manufactured which function as electrodes. In exemplary embodiments, the volume percentage of metallic chromium can vary from about 5% to about 50%. However, as the volume percentage of metallic chromium is decreased, such bricks become increasingly resistive, eventually becoming electrically insulating at very low volume percentages. By varying the volume percentage of metallic chromium the electrically resistive character of the bricks can be tuned, allowing optimization of such ceramic bricks as heat-resistant electrodes at higher volume percentages of between about 10 vol % to about 50 vol % metallic chromium, and as resistive heating elements at lower volume percentages of between about 0 vol % to about 10 vol % of metallic chromium.

Embodiments described herein may comprise, or make use of, electrically-conductive (and thermally conductive) bricks (“E-bricks”). E-bricks generate heat when a current is run through them via direct resistance heating (DRH). E-bricks may be capable of reaching very high temperatures, such as between about 1000 C to about 2000 C, and reliably cycling between a predetermined temperature range (e.g. from about 300 C to about 1800 C) on a daily basis. E-bricks may be stacked and arranged into a large structure, a thermal energy storage system (“TESS”) (a.k.a. an electrically heated thermal energy storage system E-TESS). Examples of E-bricks and E-TESS's may be found in U.S. Pat. No. 11,877,376, the contents of which are hereby incorporated, in full, by reference. Embodiments of E-TESS's may be used, for example, in various industrial and chemical processes that generate and/or consume heat, such as furnaces, kilns, refineries, power plants, allowing these processes to significantly reduce or eliminate burning of fossil fuels.

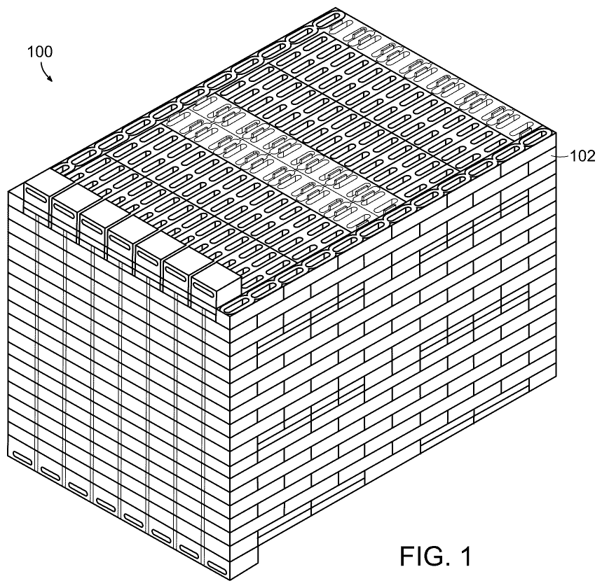

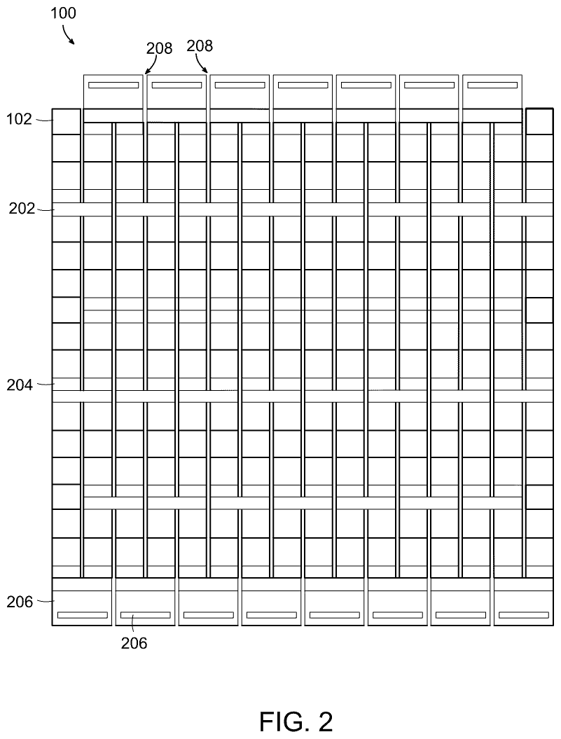

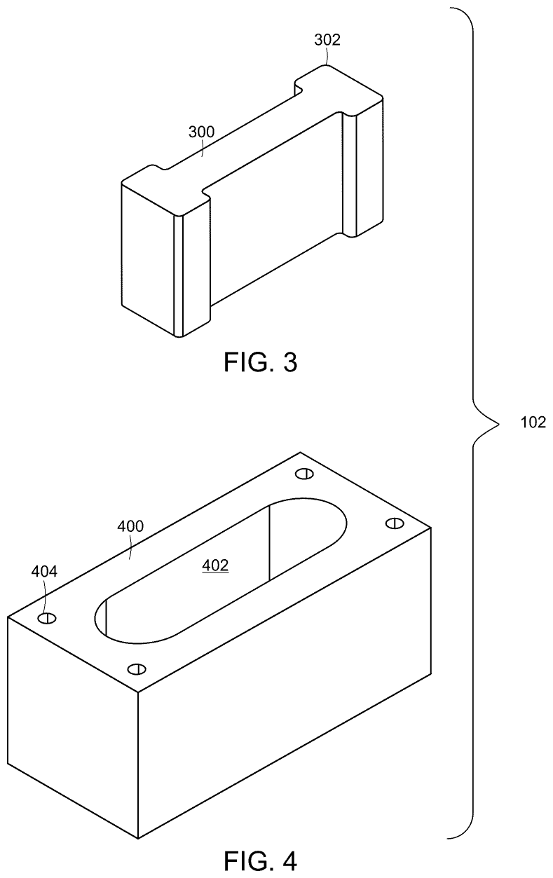

FIG. 1 shows an exemplary embodiment of an E-TESS module 100, which is primarily composed of a large quantity of electrically and thermally conductive brick assemblies 102 (“E-brick assemblies”). The E-brick assembly 102 may comprise an electrically-conductive brick 300 (“E-brick”), FIG. 3, contained within an electrically insulating (but thermally conductive) brick 400 (“I-brick”), FIG. 4. In some embodiments there may be more than one E-brick contained within an I-brick, or there may be a plurality of I-bricks that, in combination, provide insulation to one or more E-bricks. In FIGS. 1 and 2, only the I-bricks of the E-brick assemblies 102 are visible, as the E-bricks are contained in an internal region within the I-brick as shown in FIG. 4 and described below. The E-bricks in each column are physically in contact with each other and physically connected to the E-bricks in adjacent columns to form one contiguous electrical circuit when a voltage is applied across the E-TESS module 100, thereby causing an electric current to flow through the electrical circuit formed by the E-bricks.

The E-TESS module 100 generates a large amount of thermal energy when an electrical current is run through the contiguous circuit of E-bricks. The thermal energy may be stored in the E-bricks/I-bricks for extended periods of time (e.g., up to 24 hours). The thermal energy may be harvested immediately, or after it has been stored, by flowing a fluid, e.g., a gas, such as air or CO2, through E-TESS module 100. The thermal energy in the E-bricks is transferred to the I-bricks and flow paths or channels (shown in FIG. 2) between the columns of E-brick assemblies 102 allow the fluid to flow through the E-TESS module 100. This application may henceforth refer to fluid, gas, or air flowing through the flow paths or channels of E-TESS module 100, but it should be noted that these terms may be used interchangeably herein and are intended to have the same meaning. Moreover any suitable fluid, such as air or CO2, may be used to extract the heat out of E-TESS module 100. Additionally, some bricks are left out of the view in FIG. 1 to provide easier viewing.

FIG. 2 shows a side view of an embodiment of E-TESS module 100. The E-TESS module 100 comprises a large quantity of E-brick assemblies 102, arranged in a plurality of adjacent columns, which are physically and electrically interconnected in a serpentine fashion to form a contiguous three-dimensional circuit within the E-TESS module. The E-brick assemblies 102 may, in large part, be conductive only in the vertical direction (i.e., along the length of the columns), and electrically externally insulated in all other directions by the I-bricks, such that current follows the serpentine circuit (via the connected E-bricks) and does not arc between columns of E-brick assemblies 102, when there is a potential difference between the columns, e.g. in a case where different phases power are being run through adjacent columns.

Between columns there are flow paths or channels 208, through which air may flow (in the direction into or out of the page) in order to extract or harvest the thermal energy generated by the E-bricks to be used to a heat load. By flowing the air through the flow paths 208 the heat may be extracted from the E-TESS module 100 without having the air contact the E-bricks directly. This feature is especially useful because if the E-bricks comprise Cr₂O₃ and are exposed to the flowing air directly, then the Cr₂O₃ tends to volatilize, eroding the brick electrical performance over time, and also producing a toxic gas, CrO₃, which must be kept below regulated levels and as low as possible.

Current may enter the E-TESS module 100, for example, through a cable (not shown) connected to the top left corner (from the perspective of FIG. 2), and may exit the E-TESS 100 through a cable (not shown) connected to the top right corner. In addition to the E-brick assemblies 102, there may be other bricks, such as double-wide bricks 202, thin bricks 204, and end connector bricks 206 used in the E-TESS module 100.

Double-wide bricks 202 provide horizontal stabilization between columns of E-brick assemblies 102, and structural integrity of the E-TESS module 100. Double-wide bricks 202 are insulated such that current can flow vertically within columns, but does not flow across them between columns. Double-wide bricks 202 may be thinner (i.e., have a lower height) than E-brick assemblies 102, because double-wide bricks 202 span the gaps 208 between columns, and therefore partially obstruct the airflow through the gaps 208. Double-wide bricks 202 may, for example, be half the height of an E-brick assembly 102.

Thin bricks 204 are single-wide, like an E-brick assembly 102, but thinner, i.e., have a lower height than an E-brick assembly 102. Thin bricks 204 may, for example, be half the height of an E-brick assembly 102. Thin bricks 204 may be used in conjunction with double-wide bricks 202 such that the height of the double-wide brick 202 and thin brick 204 stack is equal to the height of an E-brick assembly 102. Thin bricks 204 may also be used in place of a double-wide brick 202 to maintain even levels of bricks in situations where a double-wide brick 202 is not desirable in at least one column, e.g., due to its obstructing effect on airflow, but is desirable in another column of that level.

End connector bricks 206 connect columns of bricks together, both physically and electrically. End connector bricks 206 act as end caps to columns of bricks and contain within them E-bricks which may be of a different shape that those contained in the E-brick assemblies 102 to physically and electrically connect the E-Bricks from one column of E-brick assemblies 102 to an adjacent column of E-brick assemblies 102. Current may, for example, flow down one column of bricks, perform a “U-turn” through an end connector brick 206, and then flow up the adjacent column, until it reaches the next end connector brick 206, wherein it will perform another “U-turn”, and continue in that fashion. End connector bricks may have channels or cutouts though which air may flow. End connector bricks 206 may typically have a flat bottom (or top, depending on its orientation).

FIG. 3 shows a specific embodiment of an electrically-conductive brick 300 (“E-brick”). As described above, E-bricks 300 may be configured to stack vertically with each other, which creates a part of a conductive circuit through which current and heat may flow. E-bricks 300 may be formed in many different shapes, including cross-sectional shapes of circles, rectangles, squares, or crosses, for example. FIG. 3 shows an example of a “dog bone” shaped E-brick. The E-brick 300 may have rounded or chamfered corners 302.

Referring also to FIG. 4, an E-brick 300 is configured to fit within an electrically insulating brick 400 (“I-brick”). The I-brick 400 may have a hollow internal region 402, in which an E-brick 300 may fit. An E-brick assembly 102 may comprise an E-brick 300 inside of an I-brick 400. Based on the E-brick design, the exterior shape of the I-brick and the shape of the hollow internal region 402 may have differing shapes. Other bricks may also comprise an E-brick inside of an I-brick. The hollow 402 may extend through the height of the I-brick 400 so that the E-brick 300 may conductively connect with the E-bricks above and below.

Some I-brick embodiments may comprise multiple hollows, such as a double-length I-brick with two collinear hollows, each capable of housing an E-brick. The relative sizes of the E-brick 300 and I-brick 400 may be such that there are several millimeters of clearance between the exterior sides of the E-brick and the interior sides of the I-brick hollow. For example, there may be 1, 2, 5, 7, or 10 mm of clearance. The clearance allows thermal expansion to occur at different rates between the E-brick 300 and I-brick 400, due to material and temperature differences, and reduces friction damage between the E-brick 300 and I-brick 400. The rounded corners 302 also help reduce friction damage. Other bricks may have a hollow similar to hollow 402. I-bricks may comprise pin holes 404, in which pins or rods may be placed in order to align stacks of bricks. I-bricks 400 may be made in different shapes, both of the external sides and the internal hollow 402.

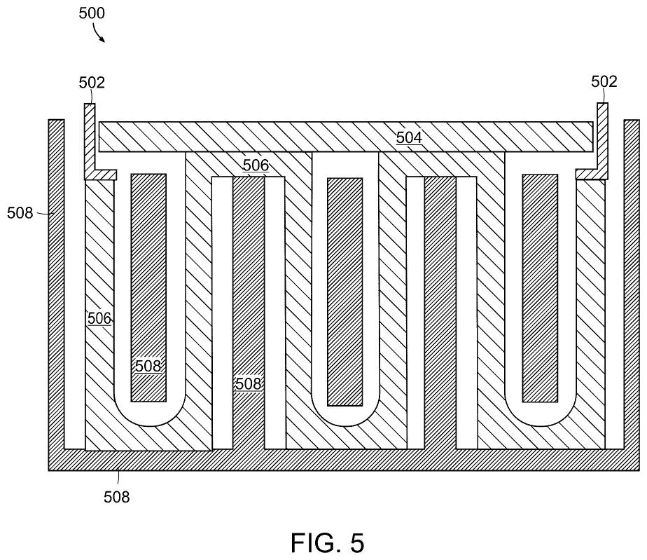

FIG. 5 shows a cross-sectional view of an embodiment of an electrically conductive brickwork module 500 according to the present disclosure. In this embodiment, electrodes 502, which are electrically connected by means of an external current source (not shown) pass through an insulating cover 504 into the electrically conductive brickwork module 500, thereby making contact with a serpentine circuit of E-bricks 506, which are resistively heated as current passes through them from the electrodes 502. The E-bricks 506 transfer heat to the thermal I-bricks 508, thereby providing an efficient thermal energy storage mechanism. Because they pass through an insulating cover, which holds the heat in to the brickwork module, the electrodes 502 in this embodiment must be able to withstand temperatures greater than about 1500 C.

Metallic chromium (chromium metal and chromium alloys) provides a material suitable for the construction of such electrodes. Chromium metal is a refractory metal that has a theoretical melting point at 1907 C (literature often quotes 1863 C likely a result of impurities). Metallic chromium exposed to air forms a strong oxide on exposed surfaces which acts as a protective layer to limit further oxidation. Such metallic chromium materials have been used as electrodes in Solid Oxide Fuel Cells (SOFC), but have caused problems as such materials are prone to vaporization of chromium, which can travel downstream and poison fuel cell cathodes. However, Cr₂O₃ brick circuits used in resistive heating and thermal energy storage systems are not sensitive to such poisoning effects making metallic chromium very suitable for such applications.

Another challenge with metal electrodes in an oxidizing environment is the formation of non-conductive oxide scales that can form and penetrate at joints between bricks in an oxide brick circuit, which can lead to breaking the circuit. A novel aspect of metallic chromium materials for the present application is that these materials form a Cr₂O₃ oxide scale that is directly compatible with electrically conductive oxide bricks comprising Cr₂O₃ which form the resistive heating elements of the disclosed thermal energy storage systems. This formation of a compatible Cr₂O₃ oxide scale also occurs for electrically conductive oxide bricks comprising Cr₂O₃ and further comprising Al₂O₃.

One challenge of using pure Cr metal electrodes is mechanical toughness and creep. However, chromium alloys which include one or more of Fe, Al, Ni, Mg, Mo, W, N, and C, can maintain or increase the melting temperature of metallic chromium while pinning grain boundaries to reduce creep. According to some embodiments, such chromium alloys have between about 5 at % to about 50 at % of metal M₁, wherein M₁ is chosen from the group consisting of Fe, Al, Ni, and combinations thereof. According to some embodiments, such chromium alloys have between about 30 at % and 70 at % metal M₂, wherein M₂ is chosen from the group consisting of Mo, W, and combinations thereof. Notably, alloys of chromium with C and N (chromium carbides and chromium nitrides, respectively) have melting points well about 1700 C and are electrically conductive. Alloys of chromium and carbon suitable for the embodiments of this disclosure may have between about 20 at % to about 45 at % carbon, in particular between about 35 at % to about 45 at % carbon. According to a particular embodiment, chromium carbide having the formula Cr₃C₂ provides a suitable alloy. Suitable alloys of chromium and nitrogen may have between about 30 at % to about 55 at % nitrogen, in particular between about 45 at % and about 55 at % nitrogen. According to a particular embodiment, chromium nitride having the formula CrN provides a suitable alloy. According to some embodiments, alloys of chromium may include one or both of C and N, wherein the combined atomic percentage C and N ranges between about 20 at % and 55 at %.

The oxide scales of metallic chromium alloys with Ni or Mg provide improved conductive behavior. According to some embodiments, a Ni content between about 5 at % and about 50 at % is suitable to provide such improved conductive behavior. According to some embodiments, an Mg content between about 0.1 at % and 5 at % is suitable to provide such improved conductive behavior. At the operating temperatures of the herein described system, which are greater than 1300 C, and in some embodiments greater than 1500 C, the compatibility of the oxide scale and the oxide bricks may lead to the interface between the scale and the bricks sintering together to strengthen mechanical properties and improve electrical connections of the oxide brick circuit.

Standard electrode materials such as platinum which allow operation at temperatures in excess of 1500 C are commercially impractical due to their high cost. However, the use of metallic chromium as an electrode material allows such high temperature operation at the electrode region at a cost significantly lower than that attainable with such standard materials. This cost advantage makes it practical both technically and commercially to operate all zones of a resistive circuit at the same high temperature, thereby simplifying design, and brick material development, and allowing for improved energy density.

Ceramic-metal composites (CERMETs) incorporate metal agglomerates into a ceramic substrate. CERMETs having a high volume percentage of metal agglomerates to ceramic substrate provide another type of electrode suitable for high temperature operation. CERMETs with lower volume percentages on the other hand have increased resistivity, making them suitable for resistive heating elements.

The addition of metallic chromium agglomerates to ceramic Cr₂O₃/Al₂O₃ bricks to form ceramic-metal composites (CERMET) provides a means for controlling the thermal and electrical properties of such composites, allowing them to be used for both electrodes and for resistive heating. By varying the ratio of metal to ceramic, thermal conductivity, electrical conductivity, and thermal shock resistance can be controlled and optimized for particular purposes. Such composites may be used for electrodes and heating elements in electrified direct resistance heating and thermal energy storage systems. These types of systems are described in U.S. application Ser. No. 17/462,244, U.S. Application 63/104,681, and PCT/US2021/048393, which are incorporated herein by reference in their entireties.

Embodiments of CERMETs having a volume fraction of metallic chromium to Cr₂O₃/Al₂O₃ of between about 5 vol % and about 50 vol %, preferably between about 10 vol % and about 50 vol % provide electrodes having the physical and electrical properties, including electrical conductivity and heat resistance, that are required for injecting current into a firebrick system according to the present application.

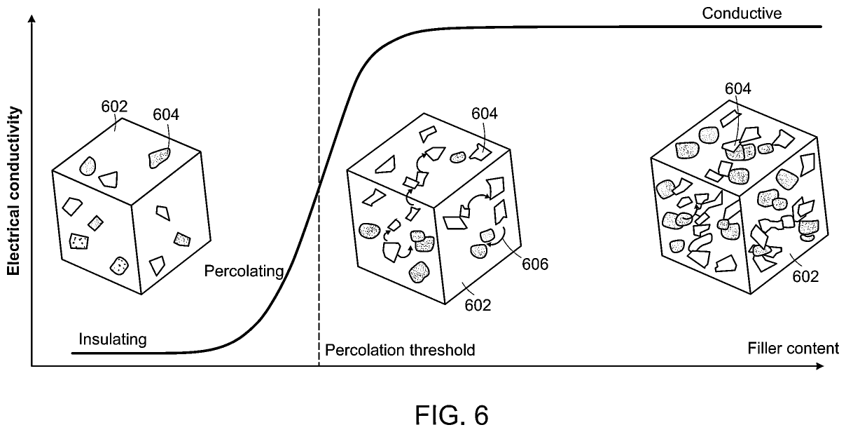

FIG. 6 illustrates how the electrical conductivity varies when metallic aggregates are incorporated at a volume percentage ranging from 5-50% into the matrix of an oxide ceramic as the particle density increases to the point that a continuous electrically and thermally conductive path is formed. Adding the agglomerates adds electrical character to the semiconductor electric behavior of the ceramic, allowing optimization of absolute resistivity and dependence on temperature. The metal agglomerates may be formed of metallic chromium, including chromium alloys, chromium carbides, and chromium nitrides.

At low volume percentages of metallic chromium agglomerates to ceramic matrix of Cr₂O₃/Al₂O₃ (ranging from no agglomerate to up to about 10 vol % agglomerate) CERMETs according to the present disclosure are largely insulating, and are functional as resistive heating elements. At higher volume percentages, conductivity increases until at volume percentages ranging from about 10 vol % to about 50 vol % the CERMETs are well suited for electrodes according to the present invention.

The current state of the art for stacked brick circuits includes graphite-based bricks and doped oxides. Graphite based bricks oxidize rapidly in air atmospheres, and doped oxides have a lower bound resistivity that requires high voltage power electronics and more electrode points. In contrast, doping of a ceramic oxide matrix with a metallic material as set forth in the present application provides a thermal shock resistant, low voltage, high temperature air-stable solution that lowers system cost at higher performance. Of particular utility are bricks made from Cr₂O₃ ceramic and doped with metallic chromium. In some embodiments, the useful electrical, thermal, and structural properties of such bricks may be further optimized by incorporating from between about 0 to about 60 wt % Al₂O₃ into the ceramic matrix.

The embodiments of the disclosure described above are intended to be merely exemplary; numerous variations and modifications will be apparent to those skilled in the art. All such variations and modifications are intended to be within the scope of the present disclosure.

What is claimed is:

1. An electrically conductive brickwork module configured for use in a resistive heating or a thermal energy storage system, comprising:
a plurality of electrically interconnected conductive bricks; and
an electrode comprising metallic chromium physically and electrically connected to at least one electrically conductive brick of the plurality of electrically conductive bricks, the electrode being configured for connection to an electrical source.

2. The electrically conductive brickwork module of claim 1, wherein the electrically interconnected conductive bricks comprise about 40 wt % to about 100 wt % Cr₂O₃.

3. The electrically conductive brickwork module of claim 2, wherein the electrically interconnected conductive bricks further comprise about 0 wt % to about 60 wt % Al₂O₃.

4. The electrically conductive brickwork module of claim 1, wherein the metallic chromium comprises a chromium alloy.

5. The electrically conductive brickwork module of claim 4, the chromium alloy including an element selected from the group consisting of Fe, Al, Ni, Mg, Mo, W, N, C, and combinations thereof.

6. The electrically conductive brickwork module of claim 4, the chromium alloy including from about 5 at % to about 50 at % of metal selected from the group consisting of Fe, Al, Ni, and combinations thereof.

7. The electrically conductive brickwork module of claim 4, the chromium alloy including from about 35 at % to about 45 at % C.

8. The electrically conductive brickwork module of claim 4, the chromium alloy including from about 45 at % to about 55 at % N.

9. The electrically conductive brickwork module of claim 4, the chromium alloy including from about 0.1 at % to about 5 at % Mg.

10. The electrically conductive brickwork module of claim 1, wherein the metallic chromium has a melting temperature above about 1300 C.

11. The electrically conductive brickwork module of claim 1, wherein the metallic chromium has a melting temperature above about 1500 C

12. The electrically conductive brickwork module of claim 1, having an exterior surface and an interior region enclosed by the exterior surface, wherein the electrode is disposed in the interior region, making electrical contact therein with the one or more electrically conductive bricks of the plurality of electrically conductive bricks.

13. The electrically conductive brickwork module of claim 12, the exterior surface being thermally insulating, the electrode being inserted through the exterior thermally insulating surface.

14. The electrically conductive brickwork module of claim 12, configured for operation at temperatures above about 1300 C.

15. The electrically conductive brickwork module of claim 12, configured for operation at temperatures above about 1500 C.

16. The electrically conductive brickwork module of claim 1, wherein the electrode comprises agglomerates of metallic chromium in a ceramic matrix comprising Cr₂O₃.

17. The electrically conductive brickwork module of claim 14, the ceramic matrix further comprising Al₂O₃.

18. The electrically conductive brickwork module of claim 14, wherein the volume percentage of metallic chromium in the electrode is between about 5 vol % and about 50%.

19. An electrode configured to provide electric power at temperatures above about 1300 C to an electrically conductive brickwork module, the electrode comprising metallic chromium agglomerates in a ceramic matrix comprising Cr₂O₃.

20. The electrode of claim 19, configured to provide electric power at temperatures above 1500 C.

21. The electrode of claim 19, wherein the percent by volume of metallic chromium in the ceramic matrix is between about 5 vol % and about 50 vol %.
